(19) United States
(12) Patent Application Publication
(10) Pub. No.: US 2019/0051286 A1
(43) Pub. Date: Feb. 14, 2019

(54) NORMALIZATION OF HIGH BAND SIGNALS IN NETWORK TELEPHONY COMMUNICATIONS

(71) Applicant: Microsoft Technology Licensing, LLC, Redmond, WA (US)

(72) Inventors: Karsten Vandborg Sørensen, Stockholm (SE); Sriram Srinivasan, Sammamish, WA (US); Koen Bernard Vos, Singapore (SG)

(21) Appl. No.: 15/676,657

(22) Filed: Aug. 14, 2017

(51) Int. Cl. G10L 13/047; H04L 29/06; G10L 19/12; G10L 25/21

(52) U.S. Cl. CPC G10L 13/047; G10L 25/21; G10L 19/12; H04L 65/604

(57) ABSTRACT

Network communication speech handling systems are provided herein. In one example, a method of processing audio signals by a network communications handling node is provided. The method includes receiving an incoming excitation signal transferred by a sending endpoint, the incoming excitation signal spanning a first bandwidth portion of audio captured by the sending endpoint. The method also includes identifying a supplemental excitation signal spanning a second bandwidth portion that is generated at least in part based on parameters that accompany the incoming excitation signal, determining a normalized version of the supplemental excitation signal based at least on energy properties of the incoming excitation signal, and merging the incoming excitation signal and the normalized version of the supplemental excitation signal by at least synthesizing an output speech signal having a resultant bandwidth spanning the first bandwidth portion and the second bandwidth portion.

### BACKGROUND

Network voice and video communication systems and applications, such as Voice over Internet Protocol (VoIP) systems, Skype®, or Skype® for Business systems, have become popular platforms for not only providing voice calls between users, but also for video calls, live meeting hosting, interactive white boarding, and other point-to-point or multi-user network-based communications. These network telephony systems typically rely upon packet communications and packet routing, such as the Internet, instead of traditional circuit-switched communications, such as the Public Switched Telephone Network (PSTN) or circuit-switched cellular networks.

In many examples, communication links can be established among one or more endpoints, such as user devices, to provide voice and video calls or interactive conferencing within specialized software applications on computers, laptops, tablet devices, smartphones, gaming systems, and the like. As these network telephony systems have grown in popularity, associated traffic volumes have increased and efficient use of network resources that carry this traffic has been difficult to achieve. Among these difficulties is efficient encoding and decoding of speech content for transfer among endpoints. Although various high-compression audio and video encoding/decoding algorithms (codecs) have been developed over the years, these codecs can still produce undesirable voice or speech quality to endpoints. Some codecs can be employed that have wider bandwidths to cover more of the vocal spectrum and human hearing range.

### OVERVIEW

Network communication speech handling systems are provided herein. In one example, a method of processing audio signals by a network communications handling node is provided. The method includes receiving an incoming excitation signal transferred by a sending endpoint, the incoming excitation signal spanning a first bandwidth portion of audio captured by the sending endpoint. The method also includes identifying a supplemental excitation signal spanning a second bandwidth portion that is generated at least in part based on parameters that accompany the incoming excitation signal, determining a normalized version of the supplemental excitation signal based at least on energy properties of the incoming excitation signal, and merging the incoming excitation signal and the normalized version of the supplemental excitation signal by at least synthesizing an output speech signal having a resultant bandwidth spanning the first bandwidth portion and the second bandwidth portion.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a system diagram of a network communication environment in an implementation.

FIG. 2 illustrates a method of operating a network communication endpoint in an implementation.

FIG. 3 is a system diagram of a network communication environment in an implementation.

FIG. 4 illustrates example speech signal processing in an implementation.

FIG. 5 illustrates example speech signal processing in an implementation.

FIG. 6 illustrates an example computing platform for implementing any of the architectures, processes, methods, and operational scenarios disclosed herein.

### DETAILED DESCRIPTION

Network communication systems and applications, such as Voice over Internet Protocol (VoIP) systems, Skype® systems, Skype® for Business systems, Microsoft Lync® systems, and online group conferencing, can provide voice calls, video calls, live information sharing, and other interactive network-based communications. Communications of these network telephony and conferencing systems can be routed over one or more packet networks, such as the Internet, to connect any number of endpoints. More than one distinct network can route communications of individual voice calls or communication sessions, such as when a first endpoint is associated with a different network than a second endpoint. Network control elements can communicatively couple these different networks and can establish communication links for routing of network telephony traffic between the networks.

In many examples, communication links can be established among one or more endpoints, such as user devices, to provide voice or video calls via interactive conferencing within specialized software applications. To transfer content that includes speech, audio, or video content over the communication links and associated packet network elements, various codecs have been developed to encode and decode the content. The examples herein discuss enhanced techniques to handle at least speech or audio-based media content, although similar techniques can be applied to other content, such as mixed content or video content. Also, although speech or audio signals are discussed in the Figures herein, it should be understood that this speech or audio can accompany other media content, such as video, slides, animations, or other content.

In addition to end-to-end or multi-point communications, the techniques discussed herein can also be applied to recorded audio or voicemail systems. For example, a network communications handling node might store audio data or speech data for later playback. The enhanced techniques discussed herein can be applied when the stored data relates to low band signals for efficient disk and storage usage. During playback from storage, a widened bandwidth can be achieved to provide users with higher quality audio.

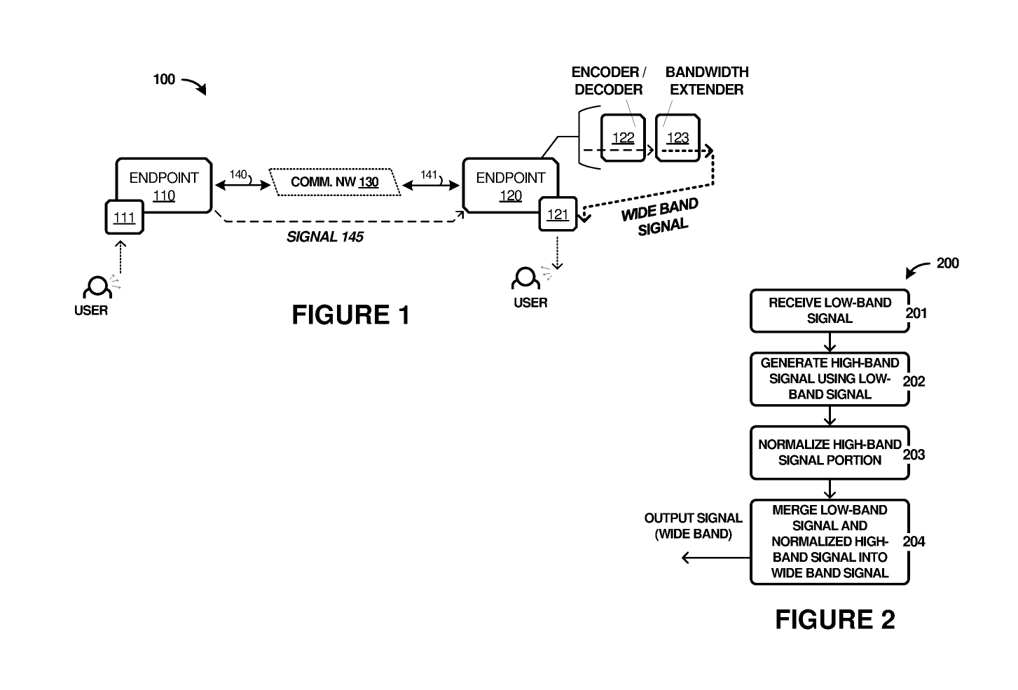

To provide enhanced operation of network content transfer among endpoints, various example implementations are provided below. In a first implementation, FIG. 1 is presented. FIG. 1 is a system diagram of network communication environment 100. Environment 100 includes user endpoint devices 110 and 120 which communicate over communication network 130. Endpoint devices 110 and 120 can include media handler 111 and 121, respectively. Endpoint devices 110 and 120 can also include further elements detailed for endpoint device 120, such as encoder/decoder 122 and bandwidth extender 123, among other elements discussed below.

In operation, endpoint devices 110 and 120 can engage in communication sessions, such as calls, conferences, messaging, and the like. For example, endpoint device 110 can establish a communication session over link 140 with any other endpoint device, including more than one endpoint device. Endpoint identifiers are associated with the various endpoints that communicate over the network telephony platform. These endpoint identifiers can include node identifiers (IDs), network addresses, aliases, or telephone numbers, among other identifiers. For example, endpoint device 110 might have a telephone number or user ID associated therewith, and other users or endpoints can use this information to initiate communication sessions with endpoint device 110. Other endpoints can each have associated endpoint identifiers. In FIG. 1, a communication session is established between endpoint 110 and endpoint 120. Communication links 140-141 as well as communication network 130 are employed to establish the communication session among endpoints.

To describe enhanced operations within environment 100, FIG. 2 is presented. FIG. 2 is a flow diagram illustrating example operation of the elements of FIG. 1. The discussion below focuses on the excitation signal processing and bandwidth widening processes performed by bandwidth extender 123. It should be understood that various encoding and decoding processes are applied at each endpoint, among other processes, such as that performed by encoder/decoder 122.

In FIG. 2, endpoint 120 receives (201) signal 145, which comprises low-band speech content based on audio captured by endpoint 110. In this example, endpoint 120 and endpoint 110 are engaged in a communication session, and endpoint 110 transfers encoded media for delivery to endpoint 120. The encoded media comprises ‘speech’ content or other audio content, referred to herein as a signal, and transferred as packet-switched communications.

The low-band contents comprise a narrowband signal with content below a threshold frequency or within a predetermined frequency range. For example, the low band frequency range can include content of a first bandwidth from a low frequency (e.g. >0 kilohertz (kHz)) to the threshold frequency (e.g. <′x′ kHz). At endpoint 110, out-of-band frequency content of the signal can be removed and discarded to provide for more efficient transfer of signal 145, in part due to the higher bit rate requirements to encode and transfer content of a higher frequency versus content of a lower frequency. In addition to the low-band content of signal 145, endpoint 110 can also transfer one or more parameters that accompany low-band signal 145.

In some examples, signal 145 comprises an excitation signal representing speech of a user that is digitized and encoded by endpoint 110, over a selected bandwidth. This excitation signal typically emphasizes ‘fine structure’ in the original digitized signal, while ‘coarse structure’ can be reduced or removed and parameterized into low bitrate data or coefficients that accompanies the excitation signal. The coarse structure can relate to various properties or characteristics of the speech signal, such as throat resonances or other speech pattern characteristics. The receiving endpoint can algorithmically recreate the original signal using the excitation signal and the parameterized coarse structure. To determine the fine structure, a whitening filter or whitening transformation can be applied to the speech signal.

Endpoint 120, responsive to receiving signal 145, generates (202) a ‘high-band’ signal using the low-band signal transferred as signal 145. This high-band signal covers a bandwidth of a higher frequency range than that of the low-band signal, and can be generated using any number of techniques. For example, various models or blind estimation methods can be employed to generate the high-band signal using the low-band signal. The parameters or coefficients that accompany the low-band signals can also be used to improve generation of the high-band signal. Typically, the high-band signal comprises a high-band excitation signal that is generated from the low-band excitation signal and one or more parameters/coefficients that accompany the low-band excitation signal. Endpoint 120 can generate the high-band signals, or can employ one or more external systems or services to generate the high-band signals.

However, the high-band signal or high-band excitation signal generated by endpoint 120 will not typically have desirable gain levels after generation, or may not have gain levels that correspond to other portions or signals transferred by endpoint 110. To adjust the gain levels of the generated high-band signal, endpoint 120 normalizes (203) the high-band signal using properties of the low-band signal. Specifically, the low-band excitation signal can be processed to determine an energy level or gain level associated therewith. This energy level can be determined for the low-band excitation signal over the bandwidth associated with the low-band signal in some examples. In other examples, an upscaling process is first applied to the low-band signal to encompass the bandwidth covered by the low-band signal and the high-band signal. Then, the upscaled signal can have an energy level, average energy level, average amplitude, gain level, or other properties determined. These properties can then be used to scale or apply a gain level to the high-band signal. The scaling or gain level might correspond to that determined for the low band signal or upscaled low band signal, or might be a linear scaling thereof.

Endpoint 120 then merges (204) the low-band signal and normalized high-band signal into an output signal. The bandwidth of the output signal can have energy across both the low and high bands, and thus can be referred to as a wide band signal. This wide band output signal can be de-whitened or synthesized into an output speech signal of a similar bandwidth. In some examples, the normalized high-band signal is also upscaled to a bandwidth of that of the output wide-band signal before merging with an upscaled low-band signal. Thus, a high-quality, wide band signal can be determined and normalized based on a low-band signal transferred by endpoint 110.

Referring back to the elements of FIG. 1, endpoint devices 110 and 120 each comprise network or wireless transceiver circuitry, analog-to-digital conversion circuitry, digital-to-analog conversion circuitry, processing circuitry, encoders, decoders, codec processors, signal processors, and user interface elements. The transceiver circuitry typically includes amplifiers, filters, modulators, and signal processing circuitry. Endpoint devices 110 and 120 can also each include user interface systems, network interface card equipment, memory devices, non-transitory computer-readable storage mediums, software, processing circuitry, or some other communication components. Endpoint devices 110 and 120 can each be a computing device, tablet computer, smartphone, computer, wireless communication device, subscriber equipment, customer equipment, access terminal, telephone, mobile wireless telephone, personal digital assistant (PDA), app, network telephony application, video conferencing device, video conferencing application, e-book, mobile Internet appliance, wireless network interface card, media player, game console, or some other communication apparatus, including combinations thereof. Each endpoint 110 and 120 also includes user interface systems 111 and 121, respectively. Users can provide speech or other audio to the associated user interface system, such as via microphones or other transducers. User can receive audio, video, or other media content from portions of the user interface system, such as speakers, graphical user interface elements, touchscreens, displays, or other elements.

Communication network 130 comprises one or more packet switched networks. These packet-switched networks can include wired, optical, or wireless portions, and route traffic over associated links. Various other networks and communication systems can also be employed to carry traffic associated with signal 145 and other signals. Moreover, communication network 130 can include any number of routers, switches, bridges, servers, monitoring services, flow control mechanisms, and the like.

Communication links 140-141 each use metal, glass, optical, air, space, or some other material as the transport media. Communication links 140-141 each can use various communication protocols, such as Internet Protocol (IP), Ethernet, WiFi, Bluetooth, synchronous optical networking (SONET), asynchronous transfer mode (ATM), Time Division Multiplex (TDM), hybrid fiber-coax (HFC), circuit-switched, communication signaling, wireless communications, or some other communication format, including combinations, improvements, or variations thereof. Communication links 140-141 each can be a direct link or may include intermediate networks, systems, or devices, and can include a logical network link transported over multiple physical links. In some examples, link 140-141 each comprises wireless links that use the air or space as the transport media.

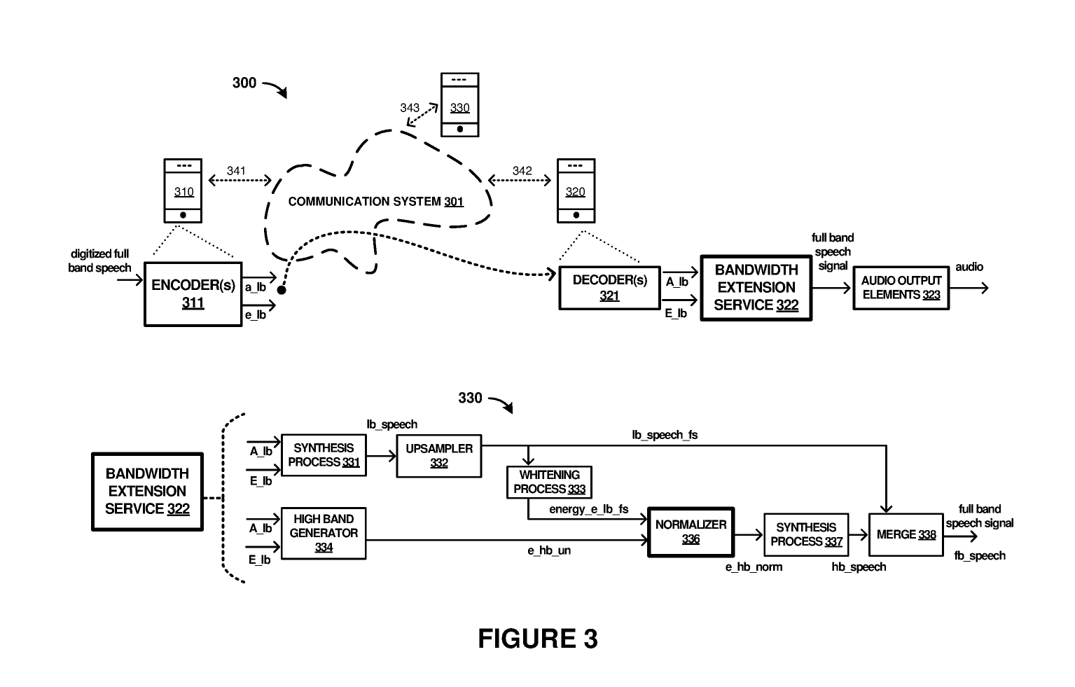

Turning now to another example implementation of bandwidth-enhanced speech services, FIG. 3 is provided. FIG. 3 illustrates a further example of a communication environment in an implementation. Specifically, FIG. 3 illustrates network telephony environment 300. Environment 300 includes communication system 301, and user devices 310, 320, and 330. User devices 310, 320, and 330 comprise user endpoint devices in this example, and each communicates over an associated communication link that carries media legs for communication sessions. User devices 310, 320, and 330 can communicate over system 301 using associated links 341, 342, and 343.

Further details of user devices 310, 320, and 330 are illustrated in FIG. 3 for exemplary user devices 310 and 320. It should be understood that any of user devices 310, 320, and 330 can include similar elements. In FIG. 3, user device 310 includes encoder(s) 311, and user device 320 includes decoder(s) 321, bandwidth extension service 322, and media output elements 323. The internal elements of user devices 310, 320, and 330 can be provided by hardware processing elements, hardware conversion and handling circuitry, or by software elements, including combinations thereof.

In FIG. 3, bandwidth extension service (BWE) 322 is shown as having several internal elements, namely elements 330. Elements 330 include synthesis filter 331, upsampler 332, whitening filter 333, high band generator 334, whitening filter 335, normalizer 336, synthesis filter 337, and merge block 338. Further elements can be included, and one or more elements can be combined into common elements. Furthermore, each of the elements 330 can be implemented using discrete circuitry, specialized or general-purpose processors, software or firmware elements, or combinations thereof.

The elements of FIG. 3, and specifically elements 330 of BWE 322 provide for normalization of speech model-generated high band signals in network telephony communications. This normalization is in the context of artificial bandwidth extension of speech. Bandwidth extension can be used when a transmitted signal is narrowband, which is then extended to wideband at a decoder in either a blind fashion or with the aid of some side information that is also transmitted from the encoder. In the examples herein, blind bandwidth extension is performed, where the bandwidth extension is performed in a decoder without any high band ‘side’ information that consumes valuable bits during communication transfer. It should be understood that bandwidth extension from narrowband to wideband is an illustrative example, and the extension can also apply to super-wideband from wideband or more generally from a certain low band to a higher band.

In FIG. 3, example methods of bandwidth extension are shown, where the bandwidth extension can be performed separately on a spectral envelope and a residual signal, which are then subsequently synthesized to obtain a bandwidth-extended speech signal. In particular, the problem of gain estimation for the high band residual signal is advantageously addressed, where the examples herein avoid the need to spend additional bits to quantize and transmit the gain parameters from the sender/encoder endpoint.

In one example operation, a supplemental excitation signal comprising a “high band” excitation signal is generated from a decoded low band excitation signal (subject to a gain factor). This high band excitation signal is then filtered with high band linear predictive coding (LPC) coefficients to generate a high band speech signal. The high band excitation signal is then advantageously appropriately scaled before applying the synthesis filter. One example scaling option is to send the (quantized) scaling factors as side information, e.g., for every 5 ms sub-frame. However, this side information consumes valuable bits on any communication link established between endpoints. Thus, the examples herein describe excitation gain normalization schemes that can operate without this side information.

Continuing this example operation, the high band excitation signal can be upsampled to a full band sampling rate (for instance, 32 kHz) to produce a signal named exc_hb_32 kHz. An estimate of the full band LPC coefficients, a_fb, is obtained through any of the state-of-the-art methods, typically employing a learned mapping between low and high or full band LPC coefficients. A decoded low band time domain speech signal is upsampled to a full band sampling rate and then analysis-filtered using the full band LPC coefficients a_fb to produce a low band residual signal, res_lb_32 kHz, sampled at the full band sampling rate. Under the assumption that a_fb whitens the full band time domain signal, this process can expect that res_lb_32 kHz and exc_hb_32 kHz have comparable energy levels. Thus, exc_hb_32 kHz is normalized to have a same or similar energy as res_lb_32 kHz, resulting in the signal exc_norm_hb_32 kHz. The normalization may be performed in subframes that are 2.5-5 ms in duration. The normalized signal exc_norm_hb_32 kHz can then be synthesis filtered using a_fb to generate the high band speech signal sampled at 32 kHz. This signal is added to the low band speech signal upsampled to 32 kHz to generate the full band speech signal

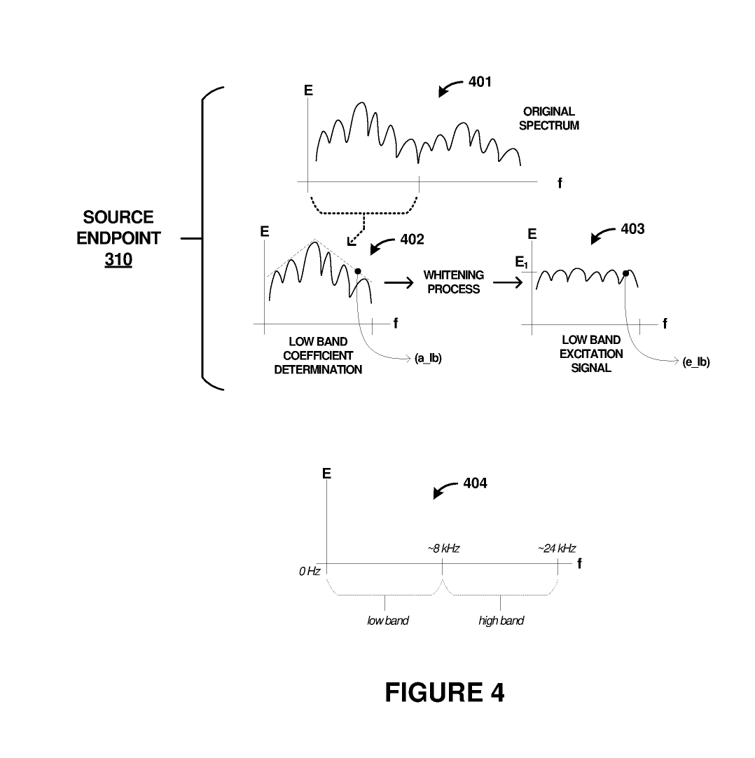

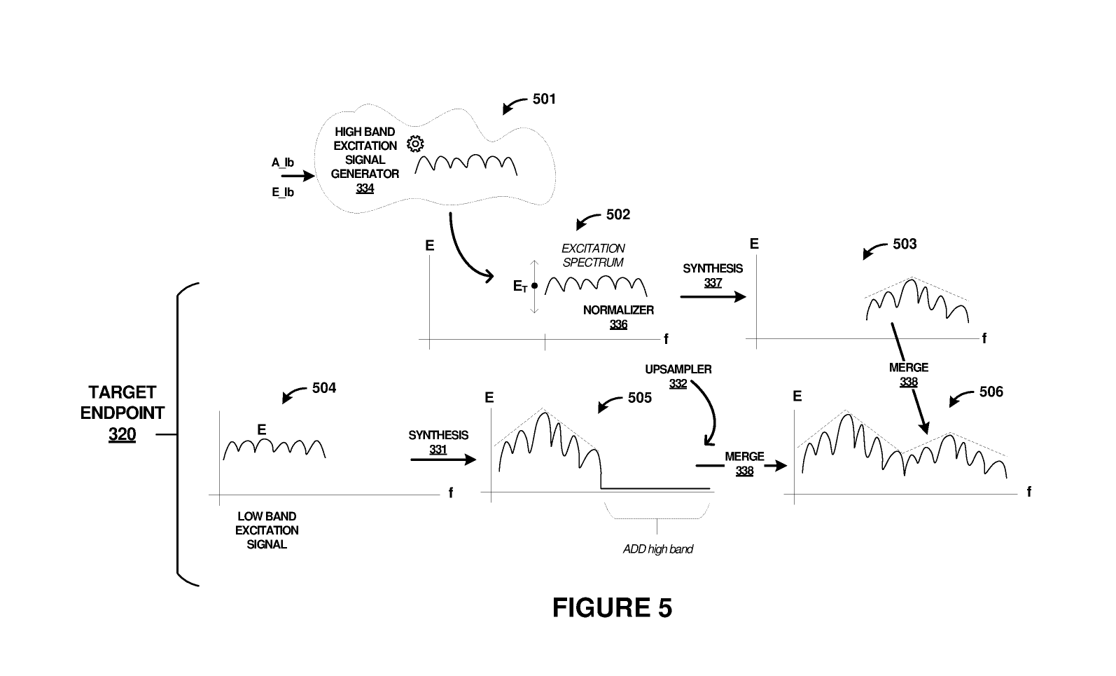

FIGS. 4 and 5 are provided to provide a more graphical view of the process described above, and also relate to the elements of FIG. 3. In FIG. 4, graphical representations of spectrums related to source endpoint 310 are shown. The terms ‘low band’ and ‘high band’ are used herein, and graph 404 is presented to illustrate one example relationship between low band and high band portions of a signal. In general, a first signal covering a first bandwidth is supplemented with a second signal covering a second bandwidth to expand the bandwidth of the first signal. In the examples herein, a low band signal is supplemented by a high band signal to create a ‘full’ band or wideband signal, although it should be understood that any bandwidth selection can be supplemented by another bandwidth signal. Also, the bandwidths discussed herein typically relate to the frequency range of human hearing, such as 0 kHz-24 kHz. However, additional frequency limits can be employed to provide further bandwidth coverage and to reduce artifacts found in too low of a bandwidth.

Graph 404 includes a first portion of a frequency spectrum indicated by the ‘low band’ label and spanning a frequency range from a first predetermined frequency to a second predetermined frequency. In this example, the first predetermined frequency is 0 kHz and the second predetermined frequency is 8 kHz. Also, a ‘high band’ portion is shown in graph 404 spanning the second predetermined frequency to a third predetermined frequency. In this example, the third predetermined frequency is 24 kHz, which might be the upper limit on the speech signal frequency range. It should be understood that the exact frequency values and ranges can vary.

After a speech signal, such as audio input from a user at endpoint 310, is captured and converted into a digital form, graph 401 can be determined that indicates a frequency spectrum of the speech signal. The vertical axis represents energy and the horizontal axis represents frequency. As can be seen, various high and low energy features are included in the graph, and this—when converted to a time domain representation—comprises the speech signal. A low band portion of the speech signal is separated from the original, such as by selecting only frequencies below a predetermined threshold frequency. This can be achieved using a low pass filter or other processing techniques. Graph 402 illustrates the low band portion.

The low band portion in graph 402 is then processed to determine both an excitation signal representation as well as coefficients that are based in part on the energy envelope of the low band portion. These low band coefficients, represented by tag “a_lb” are then transferred along with the low band excitation signal, represented by tag “e_lb” in FIG. 4. To determine the low band excitation signal, a whitening filter or process can be applied in source endpoint 310. This whitening process can remove coarse structure within the original or low band portion of the speech signal. This coarse structure can relate to resonances or throat resonances in the speech signal. Graph 403 illustrates a spectrum of the low band excitation signal. The high band information and signal content is discarded in this example, and thus any signal transfer to another endpoint can have a reduced bit rate or data bandwidth due to transferring only the low band excitation signal and low band coefficients.

Once the low band excitation signal (e_lb) and low band coefficients (a_lb) are determined, these can be transferred for delivery to an endpoint, such as endpoint 320 in FIG. 3. More than one endpoint can be at the receiving end, but for clarity in FIG. 3, only one receiving endpoint will be discussed. Endpoint 310 transfers e_lb and a_lb for delivery over communication system 301 over link 341 for delivery to endpoint 320 over link 342. Endpoint 320 receives this information, and proceeds to decode this information for further processing into a speech signal for a user of endpoint 320.

However, in FIGS. 3 and 5, enhanced bandwidth extension processes are performed to provide a wideband or ‘full’ band speech signal for a user. This full band speech signal has a better quality sound profile, and provides a better user experience during communications between endpoint 310 and 320. In some examples, a full band signal might be transferred between endpoint 310 and 320, but this arrangement would consume a large bit rate or data bandwidth over links 341-342 and communication system 301. In other examples, a low band signal might be accompanied by high band descriptors or information that can be used to recreate the high band signal based on high band processing at the source endpoint. However, this too consumes valuable bits within a data stream between endpoints. Thus, in the examples below, an even lower bitrate or data bandwidth can achieve higher quality audio transfer among endpoints using no information that describes the high band portions of the original speech signal. This can be achieved using blind estimation and speech modeling applied to the low band signal, among other considerations as will be discussed below. Technical effects include transferring high-quality speech or audio among endpoints using less bits within a given bitstream, lowering data bandwidth requirements and achieving quality audio transfer even in data bandwidth-limited situations. Moreover, efficient use of network resources is achieved by reducing the number of bits required to send a particular speech or audio signal among endpoints.

Turning now to this enhanced operation, FIG. 5 is presented that illustrates the operation of element 330 of FIG. 3. In FIG. 5, a high band signal portion 501 is generated blindly, or without information from the source endpoint describing the high band signal. To generate the high band signal portion, high band generator 334 can employ one or more speech models, machine learning algorithms, or other processing techniques that use low band information as inputs, such as the low band coefficients a_lb transferred by endpoint 310. In some examples, the low band excitation signal e_lb is also employed. A speech model can predict or generate a high band signal using this low band information. Various techniques have been developed to generate this high band signal portion. However, this model-generated high band signal portion might be of an unsuitable or undesired gain or amplitude. Thus, an enhanced normalization process is presented which aligns the high band portion with the low band portion that is received from the source endpoint.

In FIG. 5, a high band excitation signal e_hb_un is generated, as indicated in graph 502. However, as noted above, the energy level of this excitation signal is unknown or unbounded, and thus may not mesh well with any further signal processing. Thus, normalizer 336 is employed to normalize the signal levels of the generated high band excitation signal. The normalizer uses information determined for the low band excitation signal, such as energy information, energy levels, average amplitude information, or other information.

The low band excitation signal in the receiving endpoint is referred herein as E_lb, and the low band coefficients are referred to herein as A_lb, to denote different labels from the sending endpoint. FIG. 5 shows a spectrum of the low band excitation signal in graph 504. E_lb and A_lb are processed using synthesis process 331 to determine a low band speech signal, lb_speech. This lb_speech signal is then upscaled to conform to a spectrum bandwidth of a desired output signal, such as a ‘full’ bandwidth signal. In FIG. 5, graph 505 shows this lb_speech signal after upscaling to a desired bandwidth, where a portion of the signal above the low band content has insignificant signal energy presently. Moreover, graph 505 illustrates a spectrum of a speech signal determined for the low band portion using the low band excitation signal and the low band coefficients. Synthesis process 331 used to determine this lb_speech signal can comprise an inverse or reverse whitening process that was originally used to generate e_lb and a_lb in the source endpoint. Other synthesis processes can be employed.

However, the upscaled lb_speech signal is processed by whitening process 333 to determine an excitation signal of the upscaled lb_speech signal. This excitation signal then has an energy level determined, such as an average energy level or peak energy level, indicated by energy_e_lb_fs in FIG. 3. Normalizer 336 can use energy_e_lb_fs to bound the model-generated high band excitation signal portion shown in graph 502 as E_{T}. The energy properties can be determined as an average energy level computed over one or more sub-frames associated with the upscaled lb_speech signal. The sub-frames can comprise discrete portions of the audio stream that can be more effectively transferred over a packetized link or network, and these portions might comprise a predetermined duration of audio/speech in milliseconds.

This normalization process can be achieved in part because the low and high band excitation signals are both synthesized using a_fb. The low band speech signal is first upsampled and then subsequently ‘whitened’ using a_fb. If both low band and high band speech signals are whitened by the same whitening filter (parameterized by a_fb), normalizer 336 can expect that the low and high band excitation signals should have comparable energy. Normalizer 336 then normalizes the energy of the high band excitation signal using the energy of the low band excitation signal.

Once the energy level of the high band excitation signal is determined, then this signal is processed by synthesis process 337, which comprises a reverse whitening process to convert the normalized high band excitation signal (e_hb_norm) into a high band speech signal (hb_speech). The synthesized and normalized high band speech signal is shown in graph 503 of FIG. 5. The full-spectrum upscaled low band speech signal (lb_speech_fs) is then combined with the normalized high band speech signal (hb_speech) in merge process 338 to determine a full band or full spectrum speech signal (fb_speech). This full band speech signal is illustrated in FIG. 5 by graph 506.

Once fb_speech is determined, then output signals can be determined that are presented to a user of endpoint 320, such as audio signals corresponding to fb_speech after a digital-to-analog conversion process and any associated output device (e.g. speaker or headphone) amplification processes.

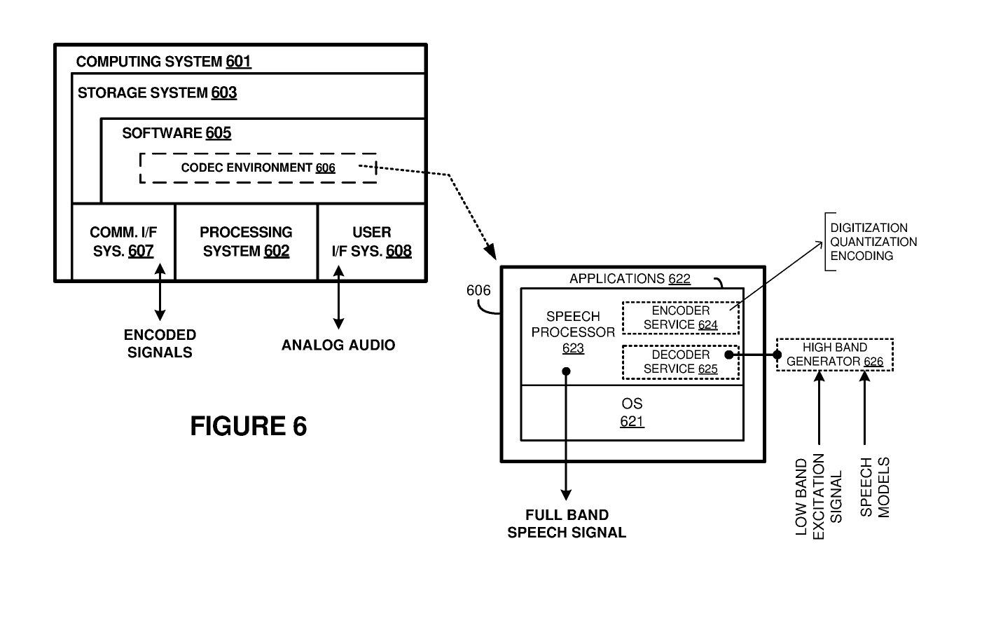

FIG. 6 illustrates computing system 601 that is representative of any system or collection of systems in which the various operational architectures, scenarios, and processes disclosed herein may be implemented. For example, computing system 601 can be used to implement any of endpoint of FIG. 1 or user device of FIG. 3. Examples of computing system 601 include, but are not limited to, computers, smartphones, tablet computing devices, laptops, desktop computers, hybrid computers, rack servers, web servers, cloud computing platforms, cloud computing systems, distributed computing systems, software-defined networking systems, and data center equipment, as well as any other type of physical or virtual machine, and other computing systems and devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 608. Processing system 602 is operatively coupled with storage system 603, communication interface system 607, and user interface system 608.

Processing system 602 loads and executes software 605 from storage system 603. Software 605 includes monitoring environment 606, which is representative of the processes discussed with respect to the preceding Figures. When executed by processing system 602 to enhance communication sessions and audio media transfer for user devices and associated communication systems, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and processing circuitry that retrieves and executes software 605 from storage system 603. Processing system 602 may be implemented within a single processing device, but may also be distributed across multiple processing devices, sub-systems, or specialized circuitry, that cooperate in executing program instructions and in performing the operations discussed herein. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for identifying supplemental excitation signals spanning a high band portion that is generated at least in part based on parameters that accompany an incoming low band excitation signal, determining normalized versions of the supplemental excitation signals based at least on energy properties of the incoming low band excitation signals, and merging the incoming excitation signals and the normalized versions of the supplemental excitation signals by at least synthesizing an output speech signal having a resultant bandwidth spanning the first bandwidth portion and the second bandwidth portion, among other operations.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software or other application software, in addition to or that include monitoring environment 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced voice/speech codecs and wideband signal processing and output. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Codec environment 606 includes one or more software elements, such as OS 621 and applications 622. These elements can describe various portions of computing system 601 with which user endpoints, user systems, or control nodes, interact. For example, OS 621 can provide a software platform on which application 622 is executed and allows for enhanced encoding and decoding of speech, audio, or other media.

In one example, encoder service 624 encodes speech, audio, or other media as described herein to comprise at least a low-band excitation signal accompanied by parameters or coefficients describing low-band coarse detail properties of the original speech signal. Encoder service 624 can digitize analog audio to reach a predetermined quantization level, and perform various codec processing to encode the audio or speech for transfer over a communication network coupled to communication interface system 607.

In another example, decoder service 625 receives speech, audio, or other media as described herein as a low-band excitation signal and accompanied by one or more parameters or coefficients describing low-band coarse detail properties of the original speech signal. Decoder service 625 can identify high-band excitation signals spanning a high band portion that is generated at least in part based on parameters that accompany an incoming low band excitation signal, determine normalized versions of the high-band excitation signals based at least on energy properties of the incoming low band excitation signals, and merge the incoming excitation signals and the normalized versions of the high-band excitation signals by at least synthesizing an output speech signal having a resultant bandwidth spanning the first bandwidth portion and the second bandwidth portion. Speech processor 623 can further output this speech signal for a user, such as through a speaker, audio output circuitry, or other equipment for perception by a user. To generate the high-band excitation signals, decoder service 625 can employ one or more external services, such as high band generator 626 which uses a low-band excitation signal and various speech models or other information to generate or reconstruct high-band information related to the low-band excitation signals. In some examples, decoder service 625 includes elements of high band generator 626.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media.

User interface system 608 is optional and may include a keyboard, a mouse, a voice input device, a touch input device for receiving input from a user. Output devices such as a display, speakers, web interfaces, terminal interfaces, and other types of output devices may also be included in user interface system 608. User interface system 608 can provide output and receive input over a network interface, such as communication interface system 607. In network examples, user interface system 608 might packetize audio, display, or graphics data for remote output by a display system or computing system coupled over one or more network interfaces. Physical or logical elements of user interface system 608 can provide alerts or anomaly informational outputs to users or other operators. User interface system 608 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

### Example 1

A method of processing audio signals by a network communications handling node, the method comprising receiving an incoming excitation signal transferred by a sending endpoint, the incoming excitation signal spanning a first bandwidth portion of audio captured by the sending endpoint. The method also includes identifying a supplemental excitation signal spanning a second bandwidth portion that is generated at least in part based on parameters that accompany the incoming excitation signal, determining a normalized version of the supplemental excitation signal based at least on energy properties of the incoming excitation signal, and merging the incoming excitation signal and the normalized version of the supplemental excitation signal by at least synthesizing an output speech signal having a resultant bandwidth spanning the first bandwidth portion and the second bandwidth portion.

### Example 2

The method of Example 1, where the first bandwidth portion comprises a portion of the resultant bandwidth lower than the second bandwidth portion.

### Example 3

The method of Examples 1-2, where determining the energy properties of the incoming excitation signal comprises upsampling the incoming excitation signal to at least the resultant bandwidth, and determining the energy properties as an average energy level computed over one or more sub-frames associated with the upsampled incoming excitation signal.

### Example 4

The method of Examples 1-3, where synthesizing the output speech signal comprises synthesizing an incoming speech signal based at least on the incoming excitation signal and the parameters that accompany the incoming excitation signal, synthesizing a supplemental speech signal based at least on the normalized version of the supplemental excitation signal, and merging the incoming speech signal and supplemental speech signal to form the output speech signal.

### Example 5

The method of Examples 1-4, where synthesizing the supplemental speech signal further comprises upsampling the supplemental excitation signal to at least the resultant bandwidth before merging with an upsampled version of the supplemental speech signal.

### Example 6

The method of Examples 1-5, where synthesizing the incoming speech signal comprises performing an inverse whitening process on the incoming excitation signal upsampled to the resultant bandwidth, and where synthesizing the supplemental speech signal comprises performing an inverse whitening process on the supplemental excitation signal upsampled to the resultant bandwidth.

### Example 7

The method of Examples 1-6, further comprising presenting the output speech signal to a user of the network communications handling node.

### Example 8

A computing apparatus comprising one or more computer readable storage media, a processing system operatively coupled with the one or more computer readable storage media, and program instructions stored on the one or more computer readable storage media. When executed by the processing system, the program instructions direct the processing system to at least receive an incoming excitation signal in a network communications handling node, the incoming excitation signal spanning a first bandwidth portion of audio captured by a sending endpoint. The program instructions further direct the processing system to at least identify a supplemental excitation signal spanning a second bandwidth portion that is generated at least in part based on parameters that accompany the incoming excitation signal, determine a normalized version of the supplemental excitation signal based at least on energy properties of the incoming excitation signal, and merge the incoming excitation signal and the normalized version of the supplemental excitation signal by at least synthesizing an output speech signal having a resultant bandwidth spanning the first bandwidth portion and the second bandwidth portion.

### Example 9

The computing apparatus of Example 8, where the first bandwidth portion comprises a portion of the resultant bandwidth lower than the second bandwidth portion.

### Example 10

The computing apparatus of Examples 8-9, comprising further program instructions, when executed by the processing system, direct the processing system to at least determine the energy properties of the incoming excitation signal by at least upsampling the incoming excitation signal to at least the resultant bandwidth and determining the energy properties as an average energy level computed over one or more sub-frames associated with the upsampled incoming excitation signal.

### Example 11

The computing apparatus of Examples 8-10, comprising further program instructions, when executed by the processing system, direct the processing system to at least synthesize an incoming speech signal based at least on the incoming excitation signal and the parameters that accompany the incoming excitation signal, synthesize a supplemental speech signal based at least on the normalized version of the supplemental excitation signal, and merge the incoming speech signal and supplemental speech signal to form the output speech signal.

### Example 12

The computing apparatus of Examples 8-11, comprising further program instructions, when executed by the processing system, direct the processing system to at least upsample the supplemental excitation signal to at least the resultant bandwidth before merging with an upsampled version of the supplemental speech signal.

### Example 13

The computing apparatus of Examples 8-12, comprising further program instructions, when executed by the processing system, direct the processing system to at least perform an inverse whitening process on the incoming excitation signal upsampled to the resultant bandwidth, where synthesizing the supplemental speech signal comprises performing an inverse whitening process on the supplemental excitation signal upsampled to the resultant bandwidth.

### Example 14

The computing apparatus of Examples 8-13, comprising further program instructions, when executed by the processing system, direct the processing system to at least present the output speech signal to a user of the network communications handling node.

### Example 15

A network telephony node, comprising a network interface configured to receive an incoming communication stream transferred by a source node, the incoming communication stream comprising an incoming excitation signal spanning a first bandwidth portion of audio captured by the source node. The network telephony node further comprising a bandwidth extension service configured to create a supplemental excitation signal based at least on parameters that accompany the incoming excitation signal, the supplemental excitation signal spanning a second bandwidth portion higher than the incoming excitation signal. The bandwidth extension service is configured to normalize the supplemental excitation signal based at least on properties determined for the incoming excitation signal, and form an output speech signal based at least on the normalized supplemental excitation signal and the incoming excitation signal, the output speech signal having a resultant bandwidth spanning the first bandwidth portion and the second bandwidth portion. The network telephone node also includes an audio output element configured to provide output audio to a user based on the output speech signal.

### Example 16

The network telephony node of Example 15, comprising the bandwidth extension service configured to determine the properties of the incoming excitation signal by at least upsampling the incoming excitation signal to at least the resultant bandwidth, and determine energy properties associated with the upsampled incoming excitation signal.

### Example 17

The network telephony node of Examples 15-16, comprising the bandwidth extension service configured to form the output speech signal based at least on synthesizing an incoming speech signal based at least on the incoming excitation signal and the parameters that accompany the incoming excitation signal, synthesizing a supplemental speech signal based at least on the normalized supplemental excitation signal, and merging the incoming speech signal and supplemental speech signal to form the output speech signal.

### Example 18

The network telephony node of Examples 15-17, where synthesizing the supplemental speech signal further comprises upsampling the supplemental excitation signal to at least the resultant bandwidth before merging with an upsampled version of the supplemental speech signal.

### Example 19

The network telephony node of Examples 15-18, where synthesizing the incoming speech signal comprises performing an inverse whitening process on the incoming excitation signal upsampled to the resultant bandwidth, and where synthesizing the supplemental speech signal comprises performing an inverse whitening process on the supplemental excitation signal upsampled to the resultant bandwidth.

### Example 20

The network telephony node of Examples 15-19, where the incoming excitation signal comprises fine structure spanning the first bandwidth portion of the audio captured by the source node, where the parameters that accompany the incoming excitation signal describe properties of coarse structure spanning the first bandwidth portion of the audio captured by the source node, and where the supplemental excitation signal comprises fine structure spanning the second bandwidth portion

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the present disclosure. Those skilled in the art will also appreciate that the features described above can be combined in various ways to form multiple implementations. As a result, the invention is not limited to the specific implementations described above, but only by the claims and their equivalents.

What is claimed is:

1. A method of processing audio signals by a network communications handling node, the method comprising:
receiving an incoming excitation signal transferred by a sending endpoint, the incoming excitation signal spanning a first bandwidth portion of audio captured by the sending endpoint;
identifying a supplemental excitation signal spanning a second bandwidth portion that is generated at least in part based on parameters that accompany the incoming excitation signal;
determining a normalized version of the supplemental excitation signal based at least on energy properties of the incoming excitation signal; and
merging the incoming excitation signal and the normalized version of the supplemental excitation signal by at least synthesizing an output speech signal having a resultant bandwidth spanning the first bandwidth portion and the second bandwidth portion.

2. The method of claim 1, wherein the first bandwidth portion comprises a portion of the resultant bandwidth lower than the second bandwidth portion.

3. The method of claim 1, wherein determining the energy properties of the incoming excitation signal comprises upsampling the incoming excitation signal to at least the resultant bandwidth, and determining the energy properties as an average energy level computed over one or more sub-frames associated with the upsampled incoming excitation signal.

4. The method of claim 1, wherein synthesizing the output speech signal comprises:
synthesizing an incoming speech signal based at least on the incoming excitation signal and the parameters that accompany the incoming excitation signal;
synthesizing a supplemental speech signal based at least on the normalized version of the supplemental excitation signal; and
merging the incoming speech signal and supplemental speech signal to form the output speech signal.

5. The method of claim 4, wherein synthesizing the supplemental speech signal further comprises upsampling the supplemental excitation signal to at least the resultant bandwidth before merging with an upsampled version of the supplemental speech signal.

6. The method of claim 4, wherein synthesizing the incoming speech signal comprises performing an inverse whitening process on the incoming excitation signal upsampled to the resultant bandwidth, and wherein synthesizing the supplemental speech signal comprises performing an inverse whitening process on the supplemental excitation signal upsampled to the resultant bandwidth.

7. The method of claim 1, further comprising:
presenting the output speech signal to a user of the network communications handling node.

8. A computing apparatus comprising:
one or more computer readable storage media;
a processing system operatively coupled with the one or more computer readable storage media; and
program instructions stored on the one or more computer readable storage media, that when executed by the processing system, direct the processing system to at least:
receive an incoming excitation signal in a network communications handling node, the incoming excitation signal spanning a first bandwidth portion of audio captured by a sending endpoint;
identify a supplemental excitation signal spanning a second bandwidth portion that is generated at least in part based on parameters that accompany the incoming excitation signal;
determine a normalized version of the supplemental excitation signal based at least on energy properties of the incoming excitation signal; and
merge the incoming excitation signal and the normalized version of the supplemental excitation signal by at least synthesizing an output speech signal having a resultant bandwidth spanning the first bandwidth portion and the second bandwidth portion.

9. The computing apparatus of claim 8, wherein the first bandwidth portion comprises a portion of the resultant bandwidth lower than the second bandwidth portion.

10. The computing apparatus of claim 8, comprising further program instructions, when executed by the processing system, direct the processing system to at least:
determine the energy properties of the incoming excitation signal by at least upsampling the incoming excitation signal to at least the resultant bandwidth and determining the energy properties as an average energy level computed over one or more sub-frames associated with the upsampled incoming excitation signal.

11. The computing apparatus of claim 8, comprising further program instructions, when executed by the processing system, direct the processing system to at least:
synthesize an incoming speech signal based at least on the incoming excitation signal and the parameters that accompany the incoming excitation signal;
synthesize a supplemental speech signal based at least on the normalized version of the supplemental excitation signal; and
merge the incoming speech signal and supplemental speech signal to form the output speech signal.

12. The computing apparatus of claim 11, comprising further program instructions, when executed by the processing system, direct the processing system to at least:
upsample the supplemental excitation signal to at least the resultant bandwidth before merging with an upsampled version of the supplemental speech signal.

13. The computing apparatus of claim 11, comprising further program instructions, when executed by the processing system, direct the processing system to at least:
perform an inverse whitening process on the incoming excitation signal upsampled to the resultant bandwidth, wherein synthesizing the supplemental speech signal comprises performing an inverse whitening process on the supplemental excitation signal upsampled to the resultant bandwidth.

14. The computing apparatus of claim 8, comprising further program instructions, when executed by the processing system, direct the processing system to at least:
present the output speech signal to a user of the network communications handling node.

15. A network telephony node, comprising:
a network interface configured to receive an incoming communication stream transferred by a source node, the incoming communication stream comprising an incoming excitation signal spanning a first bandwidth portion of audio captured by the source node;
a bandwidth extension service configured to create a supplemental excitation signal based at least on parameters that accompany the incoming excitation signal, the supplemental excitation signal spanning a second bandwidth portion higher than the incoming excitation signal;
the bandwidth extension service configured to normalize the supplemental excitation signal based at least on properties determined for the incoming excitation signal;
the bandwidth extension service configured to form an output speech signal based at least on the normalized supplemental excitation signal and the incoming excitation signal, the output speech signal having a resultant bandwidth spanning the first bandwidth portion and the second bandwidth portion; and
an audio output element configured to provide output audio to a user based on the output speech signal.

16. The network telephony node of claim 15, comprising:
the bandwidth extension service configured to determine the properties of the incoming excitation signal by at least upsampling the incoming excitation signal to at least the resultant bandwidth, and determine energy properties associated with the upsampled incoming excitation signal.

17. The network telephony node of claim 15, comprising:
the bandwidth extension service configured to form the output speech signal based at least on:
synthesizing an incoming speech signal based at least on the incoming excitation signal and the parameters that accompany the incoming excitation signal;
synthesizing a supplemental speech signal based at least on the normalized supplemental excitation signal; and
merging the incoming speech signal and supplemental speech signal to form the output speech signal.

18. The network telephony node of claim 17, wherein synthesizing the supplemental speech signal further comprises upsampling the supplemental excitation signal to at least the resultant bandwidth before merging with an upsampled version of the supplemental speech signal.

19. The network telephony node of claim 17, wherein synthesizing the incoming speech signal comprises performing an inverse whitening process on the incoming excitation signal upsampled to the resultant bandwidth, and wherein synthesizing the supplemental speech signal comprises performing an inverse whitening process on the supplemental excitation signal upsampled to the resultant bandwidth.

20. The network telephony node of claim 15, wherein the incoming excitation signal comprises fine structure spanning the first bandwidth portion of the audio captured by the source node, wherein the parameters that accompany the incoming excitation signal describe properties of coarse structure spanning the first bandwidth portion of the audio captured by the source node, and wherein the supplemental excitation signal comprises fine structure spanning the second bandwidth portion
